(19) United States
(12) Patent Application Publication
(10) Pub. No.: US 2004/0001438 A1
(43) Pub. Date: Jan. 1, 2004

(54) Method for avoiding communication collisions between co-existing plc systems on using a physical transmission medium common to all plc systems and arrangement for carrying out said method

(76) Inventors: Kurt Aretz, Isselburg (DE); Wolfgang Groting, Oberhausen (DE); Ralf Kern, Bocholt (DE); Werner Troks, Ladbergen (DE)

Correspondence Address: STAAS & HALSEY LLP, SUITE 700, 1201 NEW YORK AVENUE, N.W., WASHINGTON, DC, 20005, US

(21) Appl. No.: 10/415,497

(22) PCT Filed: Oct. 31, 2001
(86) PCT No.: PCT/DE01/04118

(30) Foreign Application Priority Data
Oct. 31, 2000 (DE) 100 53 948.3

(51) Int. Cl. H04L 1/00

(52) U.S. Cl. 370/232

(57) ABSTRACT

Method for avoiding communication collisions between co-existing PLC systems on using a physical transmission medium common to all PLC systems and arrangement for carrying out said method

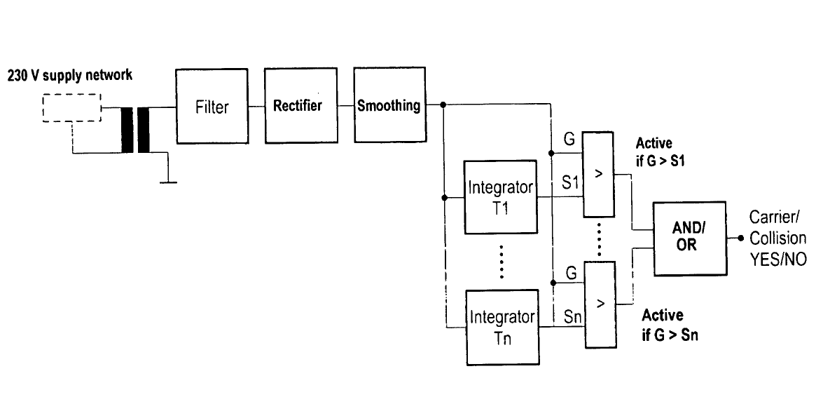

An improved method for avoiding communication collisions between co-existing PLC systems on using a physical transmission medium common to all PLC systems and arrangement for carrying out said method with regard to the reliability of the overall result are disclosed, the main principle of which is that the decision of whether or not a physical transmission line is active or not is based on a mean noise level (G) and at least one single threshold value (e.g. S1) which matches the level of interference occurring in the physical transmission channel. In a further improvement several such threshold values (S1 to Sn) are provided, which are combined to give an overall decision signal by means of a corresponding logical combination circuit. The individual, intermediate determined threshold value decisions can have a priority assigned by the logical connection circuit.

### Description

Method for avoiding communication collisions between co-existing PLC systems on using a physical transmission medium common to all PLC systems and arrangement for carrying out said method

Method for avoiding communication collisions between co-existing PLC systems on using a physical transmission medium common to all PLC systems and arrangement for carrying out said method

The invention refers to a method for avoiding communication collisions between co-existing PLC systems where a physical transmission medium common to all PLC systems is used in accordance with the preamble of claim 1. The invention also relates to an arrangement for carrying out the said method in accordance with the preamble of claim 4.

In a Powerline Communication (PLC) network there is the problem that the PLC systems connected to the network and wanting to transmit on the same physical transmission channel must first check whether the physical transmission channel is free for them. Up to now it has been possible to operate only one PLC system on the same physical transmission channel within a corresponding system range. The allocation of whether a PLC system may transmit or not must take place in a time mode and/or frequency mode and/or code duplex mode. A precondition for this, however, is that all the connected systems use the same transmission method and can thus mutually exchange data.

Many manufacturers of PLC systems use their own transmission methods so that communication overlapping a PLC system is possible only if uniform standards are implemented, at least for determining the allocation of a physical transmission channel. Such standards are at present not available.

One possibility of avoiding the simultaneous channel access in the same frequency band is described within the known DECT specification. It explains that by evaluating a so-called RSSI information a decision is reached as to whether a frequency band is free and available for transmission in this band.

A document is presently being drawn up by the European Telecommunications Standards Institute (ETSI) in which the allocation of a physical transmission channel is made dependent on the general average noise level on this physical transmission channel and on whether or not this average noise level exceeds a defined value. If this value is exceeded the physical transmission channel is regarded as occupied and no transmission by a waiting system takes place. It is assumed, conversely, that if the defined value is not exceeded the physical transmission channel is free and can be used by a waiting PLC system.

This simplification of the matter does, however, conceal the risk of spurious decisions. Very many events continuously act electrophysically on the PLC network. Thus, for instance, it can happen that the noise level on the physical transmission channel caused by building machines and/or kitchen machines can be so high that it exceeds the defined value for the permitted noise level even though nothing is being transmitted on the physical transmission channel. The physical transmission channel would thus be available for PLC systems but would not be used because the physical transmission channel would be regarded as busy. This reduces the efficiency of PLC systems.

The object of the invention is therefore, starting from a method of the type stated in the introduction, to propose an improvement that minimizes the error probability when deciding whether or not a physical transmission channel is free. It is also the task of the invention to provide a simple arrangement for carrying out the method.

This object is achieved in accordance with the invention by a method that has the method steps given in claim 1. This object is also achieved in accordance with the invention by an arrangement that has the features of claim 4.

Central to the achievement of this object is that the decision regarding whether a physical transmission channel is occupied or not is not made relative to a fixed defined threshold value that is or is not exceeded by a determined noise level on the physical transmission channel, but instead depends on at least one single simultaneously determined variable threshold value that is or is not exceeded by the determined average noise level. If the decision is reached on the basis of several determined variable threshold values, these can form a combination on which the final decision depends. The more such variable decision values are considered the more disturbance effects on the transmission channel can be taken into account or classified by appropriately combining their effects. Overall a decision which is very much more discriminating than before is enabled in this manner. The error probability of this decision is consequently minimized.

To sum up, the problem of the timing of the access to the physical PLC transmission medium is solved in a certain manner by the invention by using an intelligent evaluation of the actual noise or disturbance level on a physical PLC transmission medium. This means that no common transmission method of the various PLC systems operating with the relevant physical transmission medium is necessary. It is also not necessary to divide the available frequency range into different bands, because channel access in this implementation takes place only in the time domain (TDD method: Time Division Duplex method). Each independent PLC terminal evaluates the actual noise and disturbance levels on the power line by means of a sliding average value and decides, relative to at least one single adaptive threshold value, whether another PLC terminal is transmitting on the relevant power line. The timing of the access to the Powerline channel then takes place relative to this decision. The known CSMA (Carrier Sense Multiple Access) algorithm can, for example, then be used for the access.

Advantageous embodiments are the object of subclaims.

The means for generating an overall decision signal can then be created in such a way that the output of an active or inactive decision signal is controlled at least essentially by the same subcomponents in each case. If a significance can be attributed to the circumstance that a predetermined signal is generated, then conversely a second significance can be attributed to the circumstance that such a signal is not generated. The advantage is that hardware components can be spared.

On the other hand, separate subgroups of components that mutually switch over in given cases can also be provided for the active or inactive switching of the overall decision signal, with a corresponding significance in each case. This solution also has advantages that could possibly be used in many cases.

In the following, an exemplary embodiment of the invention is explained in more detail with the aid of a drawing.

The single drawing shows a 230 V supply network to which a terminal of a PLC system is connected. Only the essential components of the said terminal are schematically illustrated as are necessary to enable the existing terminal to make a decision regarding whether or not a required PLC channel on the 230 V supply network is busy or not.

A first of these components is a coupler that decouples the signal to be detected from the 230 V line. The decoupled signal is filtered in a filter so that the only frequencies to arrive for rectification by a rectifier are those where a transmit signal from a terminal of a different PLC system is awaited. This signal is then smoothed in a switching device for smoothing the rectified transmit signal. This smoothed signal G represents the average noise level on the selected transmission signal.

The average noise level G determined up to then is applied to a device for threshold value decisions. The determined average noise level G is furthermore supplied to a device for adapting threshold values. The device for threshold value decisions and the device for adapting threshold values each have at least one component for reaching at least one threshold value decision or adapting at least one threshold value. If several threshold values are to be taken into account, the said devices each have a corresponding number of components for reaching a corresponding number of threshold value decisions or for adapting a corresponding number of threshold values. At the same time, the determined average noise level G for one threshold value decision each and one adaptation for a threshold value are applied to a matched pair consisting of a component for the threshold value decision and for the adaptation of a threshold value. From the output of a respective component for the adaptation of a threshold value, the threshold value signal adapted by the respective component for adaptation of a threshold value is supplied to the respective relevant matched pair of further components, in addition to the determined average noise level G, relevant for reaching a threshold value decision. The respective component for reaching a threshold value decision compares the respective incoming signals with each other and, if the determined average noise level G is greater than the respective adapted threshold value still applied, e.g. S1, generates an active signal at the output.

In the exemplary embodiment in the illustration, several matched pairs of components are present for the generation of several threshold value decision signals. According to the illustration shown, all these threshold value decision signals are also combined by a suitable logic element to form an overall output signal. If the overall output signal is an active or e.g. a YES signal, this signal verifies, for example, that the investigated physical transmission channel is free and that a carrier signal, as it is called, can be sent from a PLC terminal wishing to transmit. If in the reverse case the overall output signal is an inactive signal or e.g. a NO signal, this signal verifies, for example, that the investigated physical transmission channel is busy and that no carrier signal may be transmitted from a PLC terminal wishing to transmit. If, however, such a signal is transmitted, it is to be assumed from this that a collision, a communication collision, is associated with it.

The components for adapting a threshold value in the exemplary embodiment shown are integrators each with an associated time constant T1 or up to Tn. Depending on the selected time constant, the components track the adaptive threshold value S1 or up to Sn, generated in each case from them from the determined average noise level G, at a correspondingly fast or slow rate. In this way, different rates of change in the signal for the average noise level G, that are at least partially characteristic of certain kinds of interference, are appropriately allowed for and included in the decision as to whether or not the investigated physical transmission channel is busy. If, for example, the average noise level G is raised over a longer term by a corresponding interference, then the threshold values that determine whether or not a busy physical transmission channel is present are also raised. The decision situation then in principle again corresponds to that existing before the presence of the interference. Only a transmit signal on the physical transmission channel will then lead to the corresponding set threshold values being exceeded and not the interference itself.

The logic element for combining the individual derived signals of the respective components for a respective threshold value decision can, for example, include AND or OR elements that are switched in such a way that the individual generated signals of the components for the threshold value decisions are assigned a significance before the overall output signal is influenced by them. A further improvement with regard to the reliability of the overall threshold value achieved is reached in this way.

1. Method for avoiding communication collisions between co-existing PLC systems on using physical transmission medium common to all PLC systems, the method steps of which include the determination of an average noise level (G) on the physical transmission medium and the classification of the physical transmission medium as busy or free depending on whether a specified threshold value (S) for the noise level is overshot or undershot by the determined average noise level (G), characterized in that the threshold value (e.g. S1) for the noise level is varyingly determined depending on changes over time in the determined average noise level (G) in parallel and integrally at least one single time with a respective assigned time constant (e.g. T1) and such an amplification factor assigned in each case, that in the steady state and in a situation in which a noise level is exclusively present the determined varying threshold value (e.g. S1) is greater than the determined average noise level (G), that the varying threshold values (e.g. S1 up to Sn) determined in this way in each case are each compared with the determined average noise level (G) and an active signal is generated in each case depending on the results of the particular comparison, if the comparison shows that the determined average noise level (G) is greater than the varying threshold value (e.g. S1) in comparison with it in each case, and that in a logic element that takes account of the actual significance of the particular individual determined active signal all the determined active signals are used to generate an overall decision signal for indication of the busy or not busy state of the physical transmission medium.

2. Method in accordance with claim 1, characterized in that an overall decision signal indicating that the physical transmission medium is not busy is generated in the form of an active signal if a predetermined combination of existing active signals is detected.

3. Method in accordance with claim 1 or 2, characterized in that the time constants (e.g. T1) for determining the varying threshold values (e.g. S1) are matched to these different interference signals in at least one selection of the possible different interference signals on the physical transmission medium.

4. Arrangement for carrying out the method in accordance with one of the preceding claims with means for determining an average noise level (G) on the physical transmission medium, characterized in that at least one parallel medium is provided in each case for determination of a varying threshold value (e.g. S1) relative to changes over time of the determined average noise level (G) and to a respective assigned time constant (e.g. T1), that in each case for a means for determining a varying threshold value (e.g. S1) a means is provided for comparing the determined varying threshold value (e.g. S1) with the determined average noise level (G) and for the generation of an active signal if the determined average noise level (G) is greater than the relevant determined varying threshold value (e.g. S1), and that means are provided for a logic combination of the respective determined active signals relative to a respective assigned significance and for the generation of an overall decision signal for indicating whether or not the physical transmission medium is busy.

5. Arrangement in accordance with claim 4, characterized in that the means for generating the overall decision signal are designed in such a way that the output of an active or inactive overall decision signal is at least controlled essentially in each case by the same subcomponents.

6. Arrangement in accordance with claim 4, characterized in that the means for generating the overall decision signal are designed in such a way that output of an active or inactive overall decision signal is at least controlled essentially in each case by a separate group of subcomponents.
